(19) United States
(12) Patent Application Publication
(10) Pub. No.: US 2024/0362594 A1
(43) Pub. Date: Oct. 31, 2024

(54) NATURAL LANGUAGE PROCESSING SYSTEM WITH MACHINE LEARNING FOR MEETING MANAGEMENT

(71) Applicant: Dell Products L.P., Round Rock, TX (US)

(72) Inventors: Gregory Michael Ramsey, Seattle, WA (US); David J. Linsey, Marietta, GA (US); Bijan Kumar Mohanty, Austin, TX (US)

(21) Appl. No.: 18/139,166

(22) Filed: Apr. 25, 2023

(51) Int. Cl. G06Q 10/1093; G06N 3/08

(52) U.S. Cl. CPC G06Q 10/1095; G06N 3/08

(57) ABSTRACT

An apparatus comprises a processing device configured to obtain a first data structure characterizing a description of a given meeting, to perform natural language processing of the first data structure utilizing a first machine learning model to identify topics for the given meeting, to obtain a second data structure characterizing potential invitees for the given meeting, and to create a third data structure characterizing the identified topics of the given meeting and a given potential invitee for the given meeting. The processing device is also configured to process the third data structure utilizing a second machine learning model to generate a prediction as to a likelihood of the given potential invitee attending the given meeting, and to generate an invitation to the given meeting for the given potential invitee based at least in part on the prediction of the likelihood of the given potential invitee attending the given meeting.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing, and more particularly to management of information processing systems.

### BACKGROUND

As the value and use of information continues to increase, individuals and businesses seek additional ways to process and store information. Information handling systems and other types of information processing systems may be used to process, compile, store and communicate various types of information. Because technology and information handling needs and requirements vary between different users or applications, information handling systems may also vary (e.g., in what information is handled, how the information is handled, how much information is processed, stored, or communicated, how quickly and efficiently the information may be processed, stored, or communicated, etc.). Information handling systems may be configured as general purpose, or as special purpose configured for one or more specific users or use cases (e.g., financial transaction processing, airline reservations, enterprise data storage, global communications, etc.). Information handling systems may include a variety of hardware and software components that may be configured to process, store, and communicate information and may include one or more computer systems, data storage systems, and networking systems.

### SUMMARY

Illustrative embodiments of the present disclosure provide techniques for natural language processing and machine learning-based meeting management.

In one embodiment, an apparatus comprises at least one processing device comprising a processor coupled to a memory. The at least one processing device is configured to obtain a first data structure characterizing a description of a given meeting, to perform natural language processing of the first data structure utilizing a first machine learning model to identify one or more topics for the given meeting, to obtain a second data structure characterizing one or more potential invitees for the given meeting, and to create a third data structure characterizing the identified one or more topics of the given meeting and a given one of the one or more potential invitees for the given meeting. The at least one processing device is also configured to process the third data structure utilizing a second machine learning model to generate a prediction as to a likelihood of the given potential invitee attending the given meeting, and to generate an invitation to the given meeting for the given potential invitee based at least in part on the prediction of the likelihood of the given potential invitee attending the given meeting.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for intelligent meeting scheduling in an illustrative embodiment.

FIG. 2 is a flow diagram of an exemplary process for intelligent meeting scheduling in an illustrative embodiment.

FIG. 3 shows an example of a calendar of meetings in an illustrative embodiment.

FIG. 4 shows a smart meeting scheduling framework in an illustrative embodiment.

FIG. 5 shows a topic classification engine in an illustrative embodiment.

FIG. 6 shows pseudocode for implementing a topic classification engine in an illustrative embodiment.

FIG. 7 shows a table of historical meeting attendance data in an illustrative embodiment.

FIG. 8 shows an intelligent meeting attendance prediction engine in an illustrative embodiment.

FIG. 9 shows an architecture of a dense artificial neural network-based classifier for predicting meeting attendance in an illustrative embodiment.

FIGS. 10A-10C show pseudocode for implementing a smart meeting framework in an illustrative embodiment.

FIGS. 11 and 12 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

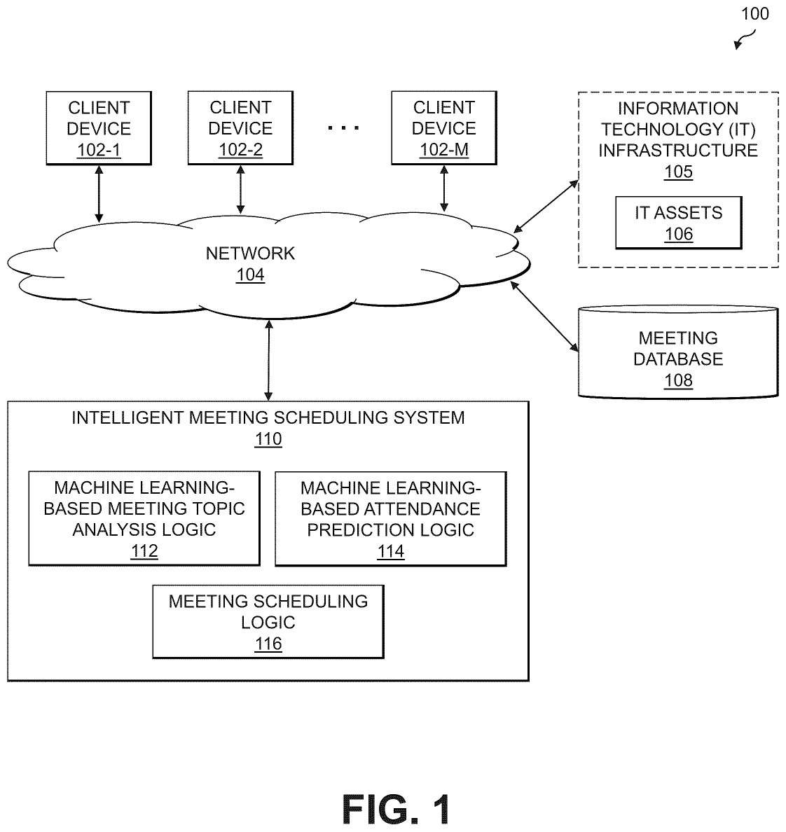

FIG. 1 shows an information processing system 100 configured in accordance with an illustrative embodiment. The information processing system 100 is assumed to be built on at least one processing platform and provides functionality for intelligent meeting scheduling. It should be noted that the term “meeting” as used herein is intended to be broadly constructed, and may include physical meetings (e.g., where one or multiple users meet physically in a same location), virtual meetings (e.g., where one or more multiple users meet virtually from different physical locations), hybrid meetings (e.g., where a first set of users meet physically in a same location and a second set of users meet virtually from one or more other physical locations), etc. Virtual or hybrid meetings may be facilitated through various communication methods, including teleconferencing, videoconferencing, etc. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a meeting database 108, and an intelligent meeting scheduling system 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the intelligent meeting scheduling system 110 is used for an enterprise system. For example, an enterprise may subscribe to or otherwise utilize the intelligent meeting scheduling system 110 for managing meetings for users which are associated with the enterprise (e.g., employees, customers, etc. which may be associated with different ones of the client devices 102 and/or IT assets 106 of the IT infrastructure 105). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different business, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The meeting database 108 is configured to store and record various information that is utilized by the intelligent meeting scheduling system 110 for scheduling of meetings. Such information may include, for example, scheduled meetings, lists of potential attendees for scheduled or to be scheduled meetings, a meeting topic corpus, historical meeting attendance data, configuration of machine learning models utilized for meeting topic analysis and meeting attendance prediction, etc. In some embodiments, one or more of storage systems utilized to implement the meeting database 108 comprise a scale-out all-flash content addressable storage array or other type of storage array. Various other types of storage systems may be used, and the term “storage system” as used herein is intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the intelligent meeting scheduling system 110, as well as to support communication between the intelligent meeting scheduling system 110 and other related systems and devices not explicitly shown.

The intelligent meeting scheduling system 110 may be provided as a cloud service that is accessible by one or more of the client devices 102 to allow users thereof to manage scheduling of meetings for various users, such as users responsible for managing the IT assets 106 of the IT infrastructure 105. The client devices 102 may be configured to access or otherwise utilize the IT infrastructure 105. In some embodiments, the client devices 102 are assumed to be associated with system administrators, IT managers or other authorized personnel responsible for managing the IT assets 106 of the IT infrastructure 105. In some embodiments, the IT assets 106 of the IT infrastructure 105 are owned or operated by the same enterprise that operates the intelligent meeting scheduling system 110. In other embodiments, the IT assets 106 of the IT infrastructure 105 may be owned or operated by one or more enterprises different than the enterprise which operates the intelligent meeting scheduling system 110 (e.g., a first enterprise provides support for meting management for multiple different customers, business, etc.). Various other examples are possible.

In some embodiments, the client devices 102 and/or the IT assets 106 of the IT infrastructure 105 may implement host agents that are configured for automated transmission of information regarding scheduled or to-be-scheduled meetings. It should be noted that a “host agent” as this term is generally used herein may comprise an automated entity, such as a software entity running on a processing device. Accordingly, a host agent need not be a human entity.

The intelligent meeting scheduling system 110 in the FIG. 1 embodiment is assumed to be implemented using at least one processing device. Each such processing device generally comprises at least one processor and an associated memory, and implements one or more functional modules or logic for controlling certain features of the intelligent meeting scheduling system 110. In the FIG. 1 embodiment, the intelligent meeting scheduling system 110 implements machine learning-based meeting topic analysis logic 112, machine learning-based attendance prediction logic 114 and meeting scheduling logic 116. The machine learning-based meeting topic analysis logic 112 is configured to parse information associated with a meeting (e.g., a proposed meeting, a to-be-scheduled meeting, a scheduled meeting for which it is desired to extend invitations to one or more users, etc.) to obtain input meeting description text, which is pre-processed and subject to feature engineering and then classified using one or more machine learning models to determine one or more meeting topics for the meeting. The machine learning-based attendance prediction logic 114 is configured to utilize the determined one or more topics for the meeting and identification of one or more potential attendees for the meeting as input to one or more machine learning models to determine a likelihood of each of the one or more potential attendees attending the meeting.

The meeting scheduling logic 116 is configured to schedule the meeting based on the determined likelihood of each of the one or more potential attendees attending the meeting. This may include, for example, selecting whether or not to extend invitations to the potential attendees based on their determined likelihood of attending the meeting. If it is determined that a given potential attendee is required for the meeting, but their predicted likelihood of attending is below some threshold, the meeting scheduling logic 116 may be configured to initiate remedial action in an effort to increase the likelihood that the given potential attendee will attend the meeting (e.g., generating one or more notifications to one or more the client devices 102 associated with the given potential attendee, generating one or more notifications to one or more users such as a supervisor or other potential attendees who may be able to persuade the given potential attended to attend the meeting, etc.). It should be noted that the scheduling of the meeting by the meeting scheduling logic 116 may in some cases be an iterative process, whereby various characteristics of the meeting (e.g., a time, a length, a list of attendees, etc.) may be adjusted with such different characteristics being processed using the machine learning-based attendance prediction logic 114 so as to determine an optimal time to schedule the meeting to ensure that one or more desired ones of the potential attendees has an increased likelihood of attending.

It is to be appreciated that the particular arrangement of the client devices 102, the IT infrastructure 105, the meeting database 108 and the intelligent meeting scheduling system 110 illustrated in the FIG. 1 embodiment is presented by way of example only, and alternative arrangements can be used in other embodiments. As discussed above, for example, the intelligent meeting scheduling system 110 (or portions of components thereof, such as one or more of the machine learning-based meeting topic analysis logic 112, the machine learning-based attendance prediction logic 114 and the meeting scheduling logic 116) may in some embodiments be implemented internal to one or more of the client devices 102 and/or the IT infrastructure 105.

At least portions of the machine learning-based meeting topic analysis logic 112, the machine learning-based attendance prediction logic 114 and the meeting scheduling logic 116 may be implemented at least in part in the form of software that is stored in memory and executed by a processor.

The intelligent meeting scheduling system 110 and other portions of the information processing system 100, as will be described in further detail below, may be part of cloud infrastructure.

The intelligent meeting scheduling system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the meeting database 108 and the intelligent meeting scheduling system 110 or components thereof (e.g., the machine learning-based meeting topic analysis logic 112, the machine learning-based attendance prediction logic 114, and the meeting scheduling logic 116) may be implemented on respective distinct processing platforms, although numerous other arrangements are possible. For example, in some embodiments at least portions of the intelligent meeting scheduling system 110 and one or more of the client devices 102, the IT infrastructure 105 and/or the meeting database 108 are implemented on the same processing platform. A given client device (e.g., 102-1) can therefore be implemented at least in part within at least one processing platform that implements at least a portion of the intelligent meeting scheduling system 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the meeting database 108 and the intelligent meeting scheduling system 110, or portions or components thereof, to reside in different data centers. Numerous other distributed implementations are possible. The intelligent meeting scheduling system 110 can also be implemented in a distributed manner across multiple data centers.

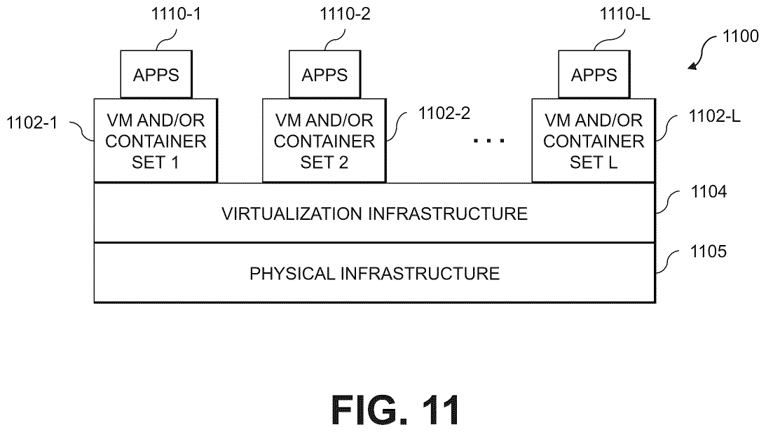

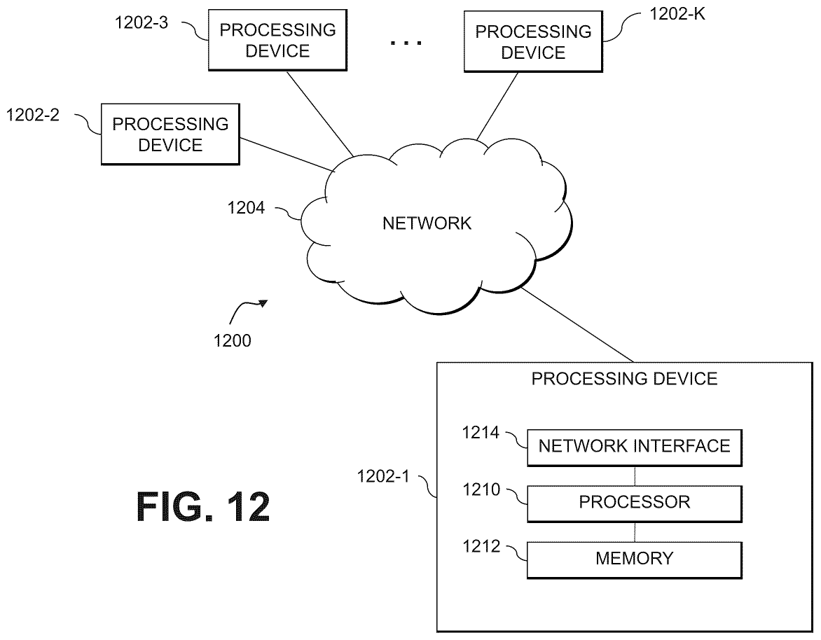

Additional examples of processing platforms utilized to implement the intelligent meeting scheduling system 110 and other components of the information processing system 100 in illustrative embodiments will be described in more detail below in conjunction with FIGS. 11 and 12.

It is to be understood that the particular set of elements shown in FIG. 1 for intelligent meeting scheduling is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

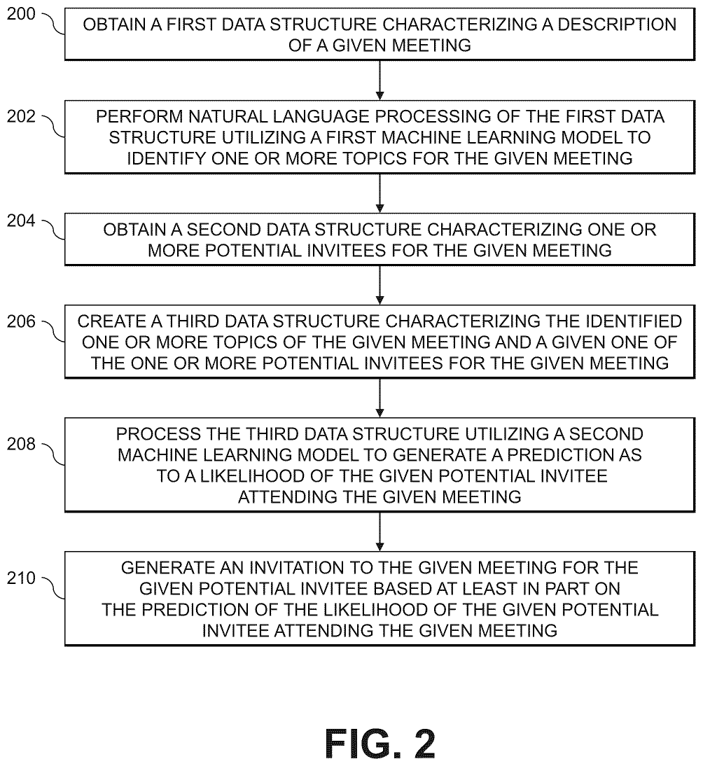

An exemplary process for intelligent meeting scheduling will now be described in more detail with reference to the flow diagram of FIG. 2. It is to be understood that this particular process is only an example, and that additional or alternative processes for intelligent meeting scheduling may be used in other embodiments.

In this embodiment, the process includes steps 200 through 210. These steps are assumed to be performed by the intelligent meeting scheduling system 110 utilizing the machine learning-based meeting topic analysis logic 112, the machine learning-based attendance prediction logic 114, and the meeting scheduling logic 116. The process begins with step 200, obtaining a first data structure characterizing a description of a given meeting. Natural language processing of the first data structure is performed in step 202 utilizing a first machine learning model to identify one or more topics for the given meeting. A second data structure characterizing one or more potential invitees for the given meeting is obtained in step 204. A third data structure characterizing the identified one or more topics of the given meeting and a given one of the one or more potential invitees for the given meeting is created in step 206. The third data structure is processed in step 208 utilizing a second machine learning model to generate a prediction as to a likelihood of the given potential invitee attending the given meeting. An invitation to the given meeting for the given potential invitee is generated in step 210 based at least in part on the prediction of the likelihood of the given potential invitee attending the given meeting.

It should be noted that the term “data structure” as used herein is intended to be broadly construed. A data structure, such as any single one of or combination of the first, second and third data structures referred to above, may provide a portion of a larger data structure, or any one of or combination of the first, second and third data structures may be combinations of multiple smaller data structures. Therefore, the first, second and third data structures referred to above may be different parts of a same overall data structure, or one or more of the first, second and third data structures could be made up of multiple smaller data structures.

The first machine learning model may comprise a Recurrent Neural Network (RNN) machine learning model. The RNN machine learning model may comprise a bi-directional RNN with Long Short Term Memory (LS™). The first machine learning model may be trained utilizing a corpus of meeting topics associated with an enterprise for which the given meeting is scheduled.

The second machine learning model may comprise a binary classification model that provides, as output, a prediction of whether or not the given potential invitee will attend the given meeting. The second machine learning model may be trained utilizing information characterizing one or more historical meetings of an enterprise for which the given meeting is scheduled, the information characterizing the one or more historical meetings including, for each historical meeting, one or more meeting topics, one or more organizers, one or more attendees, and a level of interaction of each of the one or more attendees. The second machine learning model may comprise a dense artificial neural network-based classifier comprising an input layer, one or more hidden layers, and an output layer. The input layer may be configured to receive values for a set of independent variables characterizing a likelihood of the given potential invitee attending the given meeting. The set of independent variables may comprise: a date and time of the given meeting; the identified one or more topics for the given meeting; and an organizer of the given meeting. Each of the one or more hidden layers may comprise a set of neurons utilizing a first activation function, and the output layer may comprise a single neuron utilizing a second activation function. The first activation function may comprise a Rectified Linear Unit (ReLU) activation function, and the second activation function may comprise a sigmoid activation function.

The generated invitation to the given meeting for the given potential invitee may specify an attendee class for the given potential invitee based at least in part on the prediction of the likelihood of the given potential invitee attending the given meeting, the attendee class comprising one of a required attendee and an optional attendee. The FIG. 2 process may further include obtaining post-meeting feedback for the given meeting, and utilizing the post-meeting feedback for updating a training of the second machine learning model. The post-meeting feedback may characterize at least one of: whether the given potential invitee attended the given meeting; and a level of interaction of the given potential invitee during the given meeting.

Meetings are essential for various businesses, organizations and other entities. However, due to the need to share information, the desire to “loop others in,” and the desire to not be a roadblock, users are often invited to more meetings than they need to attend live. Meeting recordings, automated summaries, and other techniques may be used to help recap if something critical is missed is a user is unable to attend a meeting. Some meeting scheduling systems allow for an organizer to select whether particular attendees are “required” or “optional” for a given meeting. There is a need, however, for technical solutions which can factually determine situations in which a given user or attendee is invited to a meeting, but where the presence of the given user is not critical to the meeting. The technical solutions described herein provide functionality for helping meeting organizers to identify recommended and unnecessary or optional attendees for a given meeting, for suggesting a personal attendance criticality level for recipients of meeting invitations, and for reviewing or recapping the participation level of different attendees to the meeting organizer after the given meeting has taken place to improve subsequent meeting scheduling effectivity.

A user sitting in a virtual or physical meeting, only to find out that the user did not need to be at the meeting, is an all-too-common frustration. In an ideal scenario, a meeting organizer would provide a concise meeting agenda with expected topics and outcomes, and surgically invite the right attendees to ensure that no one's time is wasted. Unfortunately, this ideal scenario does not occur regularly and is difficult to achieve for large organizations with many users.

Complex programs, tasks and other initiatives require specialized individuals, and collaboration across these individuals may be key to successful outcomes in any complex, large-scale initiative. In a large organizational environment, it can be a challenge for an organizer to know who best to invite to have a valuable meeting. It is also a challenge for attendees to know whether they should attend a meeting or not, especially when meeting on new topics or with new or unfamiliar sets of individuals. While some meeting scheduling software provides functionality for allowing an organizer to specify required and optional attendees, such functionality is rarely used by meeting organizers, is subjective, and its Boolean nature does not provide enough nuance if potential attendees have multiple overlapping demands and want to know where they are most likely needed.

The technical solutions described herein provide a multi-faceted approach for both meeting organizers and attendees to factually determine how important attendance is for a given meeting based on the expected goals of the given meeting and other demands (e.g., such as other meetings which may conflict with or partially overlap the given meeting). The technical solutions also enable a feedback loop for continued refinement of future suggestions. The technical solutions thus provide an intelligent meeting scheduling framework which ensures the best use of time, and provides both organizers and attendees of meetings with clear expectations to ensure successful meeting outcomes.

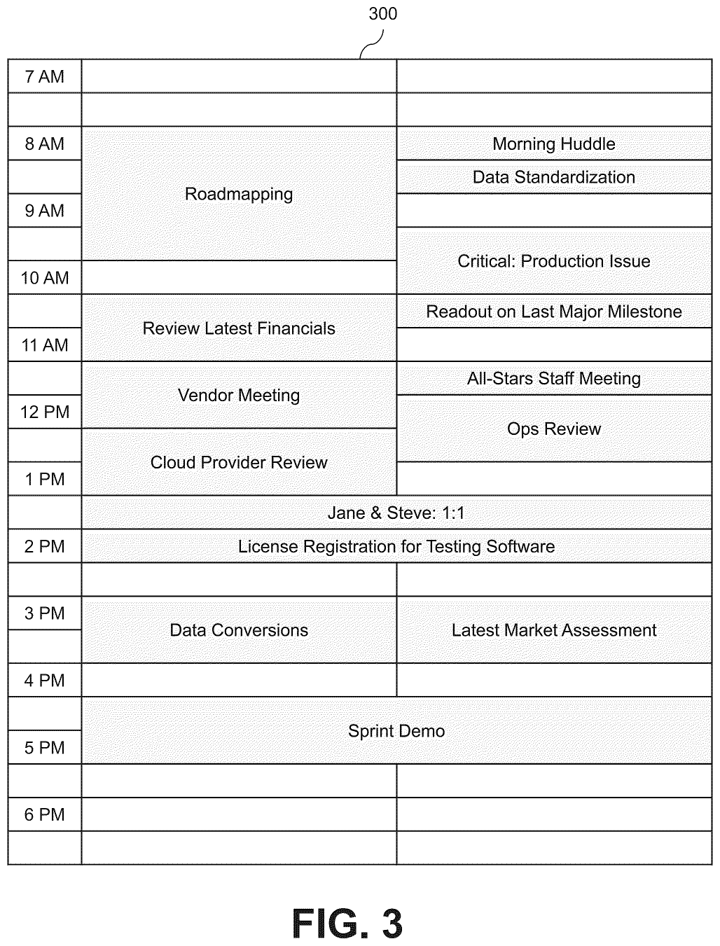

Consider a company with thousands of employees, spread into multiple nested organizations or divisions (e.g., finance, sales, service, etc.). An initiative, such as launching a new product offering to market, may require involvement across multiple organizations and multiple meetings (e.g., with individuals from one or more of the multiple organizations) to make progress on the initiative. This results in various outcomes, including: (1) organizers may set up large-scale meetings, sometimes on a recurring basis, as generic working sessions or reviews which may only be selectively relevant to a subset of the invited attendees; (2) organizers often set all invited attendees as “required” just in case, making the designation of required/optional attendee an unreliable metric for determining whether to attend a given meeting; (3) invited attendees may decide, based on their own judgment, not to attend a given meeting (e.g., due to something which is perceived to be more important coming up); (4) invited attendees may not specifically decline a meeting invitation, or may accept a meeting invitation and not attend its associated meeting; (5) organizers may need to “chase down” invited attendees in advance to ask them if they plan to attend, or may round up invited attendees at the start of a meeting to ask if they will join the meeting; (6) even if there is no calendar conflict, invited attendees may want to find more non-meeting time in their schedule to accomplish tasks and thus not join a given meeting; etc. FIG. 3 shows an example of a calendar 300 for a given user, illustrating how the proliferation of meetings may result in a user being overburdened with little free time between scheduled meetings, and with multiple conflicting meetings.

Many of the technical problems described herein are most common for meetings which are cross-functional, first-time or one-off, or for meetings with numerous attendees invited (e.g., which is itself a cause of technical problems). These are all situations where meeting organizers and attendees are getting familiar with each other, their roles, and their expertise with respect to topics at hand. It should be noted that such technical problems are not limited to the example provided (e.g., an initiative for launching a new product offering to market). Various types of meetings (e.g., related to launching a new offering, creating a statement of work, a technical discussion on a specific problem, a review meeting, etc.) will each have their own fingerprint of a theme or topic for critical and non-critical attendees within an organizational mesh.

Beyond simple calendar availability, in large organizations it may be unclear to meeting organizers who are the best attendees to invite to a given meeting. This may be due to unfamiliarity with the experts for the topic at hand, a lack of deep knowledge of what each invitee can bring to the discussion, etc. This can result in over-inviting attendees, and unpredictable attendance. Further, invitees to meetings are often unsure of whether they should attend a meeting or assume that, since they were invited, that they must attend even if the invitees do not fully understand the purpose of the meeting. Still further, meeting organizers do not receive feedback as to whether the invitee list for a given meeting was appropriate, such that they can adjust meeting invitations in the future to have more productive meetings on the same or similar topics.

The technical solutions described herein provide functionality for recommending whether potential meeting invitees should be invited to a meeting (or re-invited to a next meeting). In some embodiments, the recommendation includes or is associated with a granular score as to the likely relevance for each potential invitee which can be used to better make prioritized judgment calls of whether to attend a given meeting. The technical solutions also enable post-meeting feedback to the meeting organizer and/or attendees, with such feedback indicating whether the right attendees were originally invited (e.g., to reduce over-inviting, to allow attendees to better understand whether they should attend meetings for the same or similar topics in the future, etc.). The technical solutions thus provide a recommendation system which can consider a meeting coordinator or organizer's intent. Due to the various reasons for meetings, there may be valid reasons for a large or excessive invite list which only the meeting coordinator or organizer would understand. Thus, the recommendations provided using the technical solutions described herein may be used as one facet or factor for consideration in scheduling meetings.

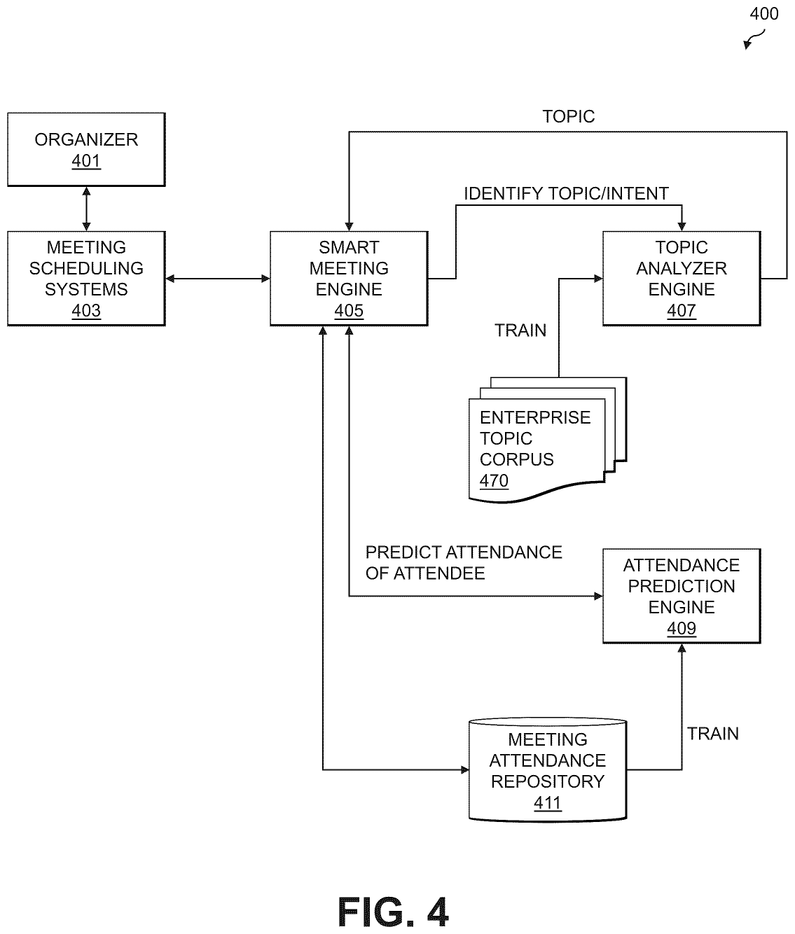

FIG. 4 shows a smart meeting framework 400, which includes a meeting organizer 401 which interacts with one or more meeting scheduling systems 403 in order to schedule one or more meetings. The meeting scheduling systems 403 may include, but are not limited to, office applications, e-mail applications, video meeting or calling applications, etc. The meeting scheduling systems 403 are configured to interact with a smart meeting engine 405, which is configured to generate predictions as to whether potential invitees are likely to join a given meeting. The predictions may be generated based on a variety of factors, including but not limited to the topic or intent of the given meeting, the type of the given meeting, the organizer of the given meeting, the date and time of the given meeting, etc. The smart meeting engine 405 is configured to utilize a topic analyzer engine 407 to determine the topics for the given meeting. To do so, the smart meeting engine 405 may supply a meeting description or other characteristics to the topic analyzer engine 407, which is trained utilize an enterprise topic corpus 470, and returns one or more topics for the given meeting. The smart meeting engine 405 then utilizes an attendance prediction engine 409 to generate predictions as to whether potential invitees will or will not attend the given meeting. To do so, the smart meeting engine 405 may provide the one or more topics identified utilizing the topic analyzer engine 407, as well as other factors such as the type of the given meeting, the organizer of the given meeting, the date and time of the given meeting, etc. The attendance prediction engine 409 may be trained utilizing information stored in a meeting attendance repository 411 (e.g., information characterizing historical attendance at different meetings). The smart meeting engine 405 may also access the meeting attendance repository 411 (e.g., to update information stored therein, possibly based on post-meeting feedback as described elsewhere herein).

In some embodiments, the smart meeting engine 405 may determine a priority score of a given meeting for potential attendees, where the potential attendees may use such priority scores to decide whether or not to join the given meeting. In some cases, however, a priority score (e.g., a numerical priority score between 1-5, between 1-10, etc.) may not be particular useful for a potential attendee to make the decision as to whether or not to join the given meeting. Thus, the smart meeting engine 405 in other embodiments may use a classification model with two classes of possibilities (e.g., will attend or will not attend). The classification model, which may be a machine learning model, may utilize various factors, including but not limited to the topics being discussed in a given meeting, the type of the given meeting, the organizer of the given meeting, the date and time of the given meeting, etc., to generate predictions as to whether specific potential invitees will or will not join the given meeting. Such capability is achieved utilizing the topic analyzer engine 407 which derives the topics of the given meeting as well as the type of the given meeting, the meeting attendance repository 411 which contains information related to historical meetings (e.g., date and time, topics, organizer, invitees, attendance status of the invitees, etc.), and the attendance prediction engine 409 which predicts the future attendance of potential attendees based at least in part on their past attendance for historical meetings on various topics.

When the meeting organizer 401 adds invitees to a given meeting via the meeting scheduling systems 403, the smart meeting engine 405 will leverage the topic analyzer engine 407 to identify the topics of the given meeting (e.g., services architectures, services staff, new product rollout, manger one-on-one, etc.) which will be used as input to the attendance prediction engine 409 to predict if a given invitee will or will not join the given meeting based at least in part on the given invitee's historical participation in meetings as determined utilizing the meeting attendance repository 411. The meeting attendance repository 411 may comprise a metadata repository of historical participation of each meeting in an enterprise. The metadata may comprise the meeting topics discussed during the historical meetings, the date and times of the historical meetings, each invitee/attendee of the historical meetings and their attendance status, etc. This metadata can be harvested from the meeting scheduling systems 403 (e.g., Outlook and other types of software which may be used to schedule meetings) and stored in the meeting attendance repository 411 by the smart meeting engine 405. The metadata stored in the meeting attendance repository 411 is used to train the attendance prediction engine 409 (e.g., one or more neural networks or other machine learning-based classifiers) for prediction of future attendance in scheduled or to-be-scheduled meetings.

The topic analyzer engine 407 is configured to utilize natural language understanding (NLU) and neural networks or other machine learning models to analyze meeting description information in order to classify the topics or intents (e.g., the topics to be discussed) of a given meeting. In some embodiments, the meeting description is considered as a time series model, where the words come one after another in time/space. Thus, the topic analyzer engine 407 may utilize a Recurrent Neural Network (RNN) machine learning model for analyzing the meeting description. To better understand context and to analyze the message most efficiently, some embodiments utilize a bi-directional RNN which uses two separate processing sequences (e.g., one from left to right and the other from right to left). As RNNs have the tendencies for exploding or vanishing gradient issues for longer and complex messages, the specific type of bi-directional RNN used may be a bi-directional RNN with Long Short-Term Memory (LS™) for the NLU analysis.

RNNs provide a neural network architectures in which the previous step's output feeds into the current step's input. In a traditional neural network architecture (e.g., a feed-forward network), input and output are independent. In language processing, however, it is important to remember the previous words before predicting the next word of a sentence. This is where the RNN architecture makes a difference, by having the hidden state recognize some words in the sentence. If the sentences are too long, some of that previous information may not be available in the limited hidden state, which requires the bi-directional processing of the sentence (e.g., from the past and future in two sequences in parallel) as done in a bi-directional RNN. LS™ introduces advanced memory units and gates to the an RNN, which may be viewed as providing knobs and dials which can improve model accuracy and performance.

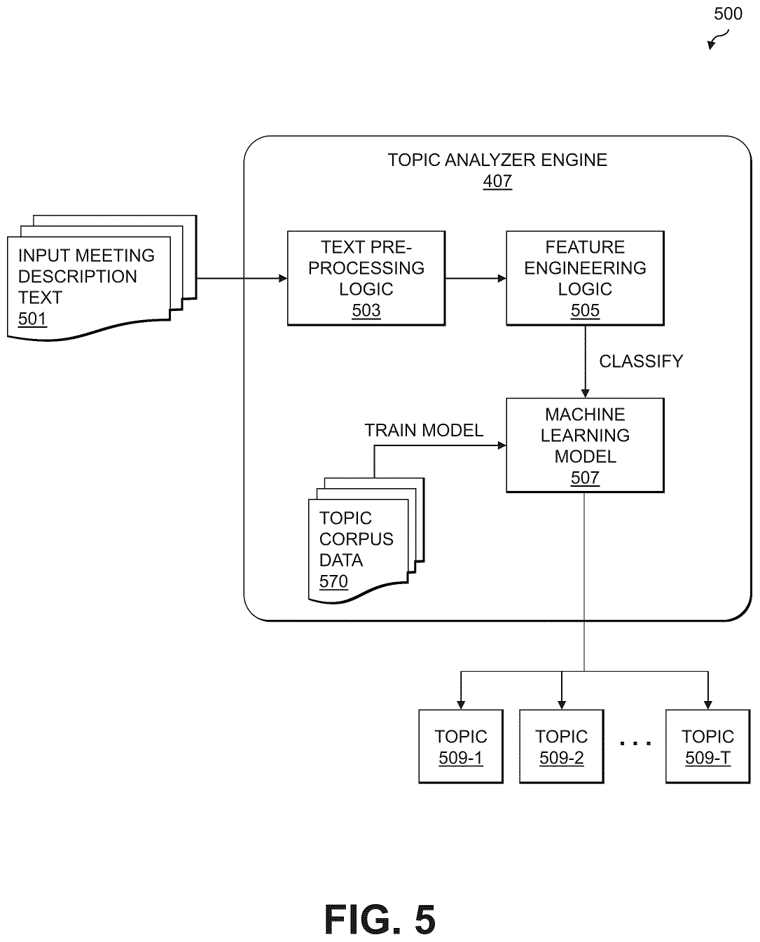

The intent analysis starts with a set of corpus data that will be used to train the model (e.g., the bi-directional RNN with LS™ machine learning model). This corpus data, represented in FIG. 4 as the enterprise topic corpus 470, contains words and phrases as well as the topics/intents associated with each of these. FIG. 5 shows a detailed view of a framework 500 for topic classification, in which input meeting description text 501 is provided to the topic analyzer engine 407 implementing text pre-processing logic 503, feature engineering logic 505, and a machine learning model 507 (e.g., a bi-directional RNN with LS™). The text pre-processing logic 503 pre-processes the input meeting description text 501 to clean any unwanted characters, stop words, etc. The text pre-processing logic 503 may also be configured to perform stemming and lemmatization, change text to lowercase, remove punctuation and bad characters, etc. Once the text pre-processing data cleanup is done, the input list of words (e.g., in the sentence or sentences of the input meeting description text 501) is tokenized using the feature engineering logic 505. The feature engineering logic 505 may use various approaches for word tokenization, such as using the Keras library, the Natural Language Toolkit (NLTK) library, etc. In some embodiments, it is assumed that the Keras Tokenizer class is used to index the tokens. After tokenization is done, the tokens may be padded to make them of equal length for processing by the machine learning model 507. Similar processing (e.g., tokenization and padding) may be performed for topics in the topic corpus data 570. The topic list is indexed and then fed into the machine learning model 507. The topics may be one-hot encoded before being provided to the machine learning model 507.

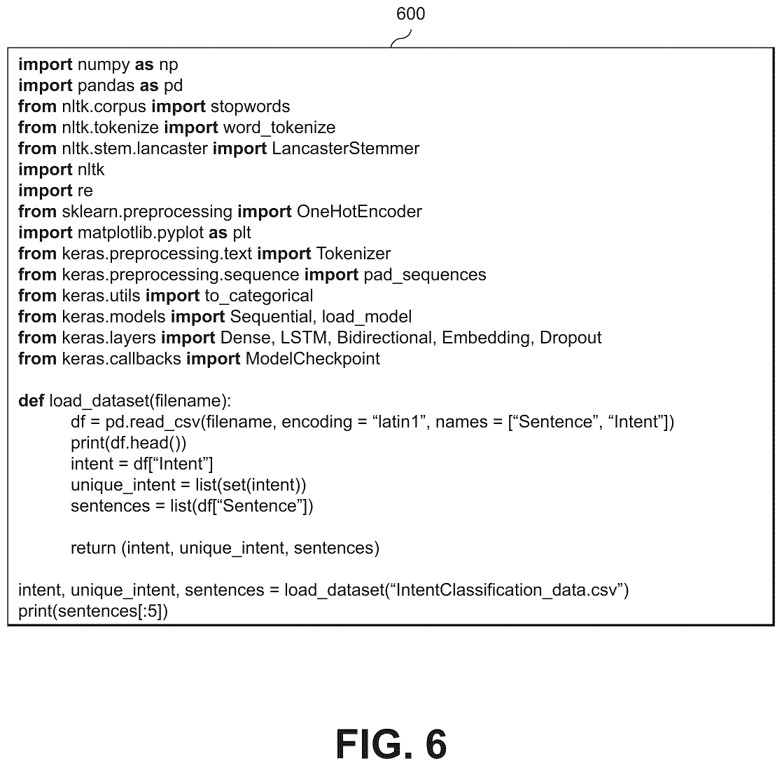

The topic corpus data 570 is used to train the machine learning model 507 before predicting the topic for an incoming message (e.g., the input meeting description text 501). As noted above, the machine learning model 507 may comprise a bi-directional RNN model with LS™, which may be created using the Keras library. Various parameters may be passed during creation of the machine learning model 507 (e.g., an optimizer choice such as the Adam optimizer, activation function such as Softmax, a batch size, a number of epochs, etc.). These parameters, particularly the batch size and the number of epochs, may be tuned to get the best performance and accuracy for the machine learning model 507. After the machine learning model 507 is trained with the topic corpus data 570 (e.g., enterprise topic corpus training data), the machine learning model 507 may be used to predict the topics/intents of the incoming message (e.g., the input meeting description text 501). The accuracy of the machine learning model 507 may be calculated for hyperparameter tuning. The machine learning model 507 will output which of a set of topics 509-1, 509-2, . . . 509-T (collectively, topic 509) best match the input meeting description text 501. In some embodiments, only a single one of the topics 509 is selected for the input meeting description text 501. In other embodiments, two or more of the topics 509 may be selected for the input meeting description text 501 (e.g., ones of the topics 509 determined to exhibit at least a threshold match with the input meeting description text 501). The topics 509 may be varied, such as topics related to services staff of an enterprise, an enterprise architecture, product rollout, road-mapping, market assessments, demonstrations, learning/educational, etc. FIG. 6 shows pseudocode 600 for implementing the topic analyzer engine 407 utilizing the Python programming language with NumPy, Pandas, Keras and NLTK libraries.

Functionality of the attendance prediction engine 409 will now be described in further detail. The attendance prediction engine 409 is responsible for predicting, with a high degree of accuracy, if a given user (e.g., a potential invitee/attendee) will or will not join a given meeting. This prediction not only helps the meeting organizer 401, but also the given user. For example, knowing in advance that a given user is not predicted to join the given meeting, the meeting organizer 401 can switch the given user to an optional attendee, or possibly not even include the given user as an invitee at all. Similarly, knowing the prediction of whether the given user will join the given meeting can also be used to reinforce the given user's decision as to whether to join the meeting (e.g., such as the given user choosing between conflicting meetings based on respective predictions of whether the given user will attend the conflicting meetings). If the given user decides to join the given meeting irrespective of a prediction that the given user will not join the given meeting, then future predictions for the given user can reflect this decision. The attendance prediction engine 409 provides such capabilities by leveraging a sophisticated neural network-based classifier machine learning model, which is trained using historical meeting attendance data stored in the meeting attendance repository 411. By training using multi-dimensional features such as topic, date and time, organizer, attendees, their participation class, etc., the attendance prediction engine 409 can predict with a high degree of accuracy whether a given user (e.g., a potential invitee/attendee) will or will not join the given meeting.

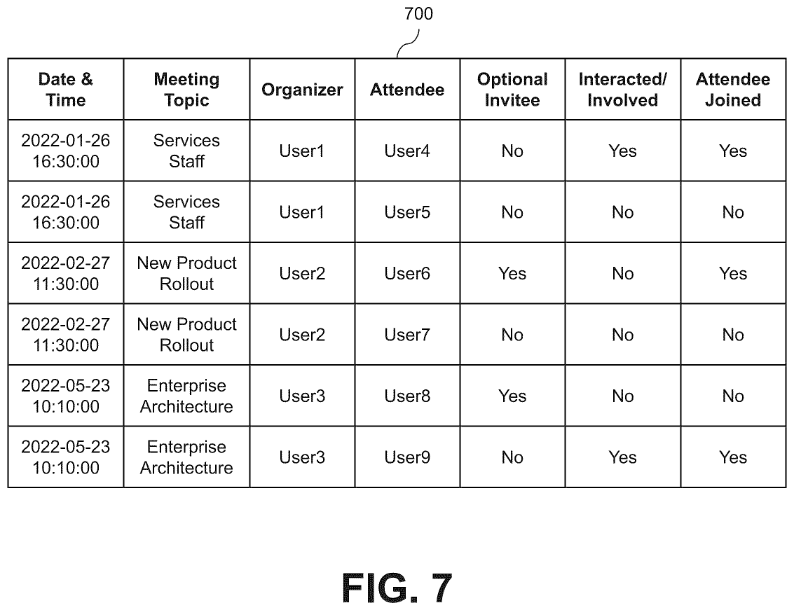

FIG. 7 shows a table 700 of sample data with features and targets which may be part of the meeting attendance repository 411 used in training the attendance prediction engine 409. In this example, features for historical meetings include the date and time, meeting topic, organizer, attendee, status as an optional invitee, whether the attendee interacted or was involved during the historical meeting, whether the attendee joined the historical meeting, etc. Here, the target may be the last column indicating whether attendees joined historical meetings. Once the data (e.g., from the table 700 or more generally the meeting attendance repository 411) is harvested and collected, data engineering and exploratory data analysis may be performed to identify the important features/columns that can influence the target variables (e.g., attendance). This helps in identifying any unnecessary columns or features, as well as features which are highly correlated. This can provide improvements by reducing the data dimension and model complexity while also improving performance and accuracy.

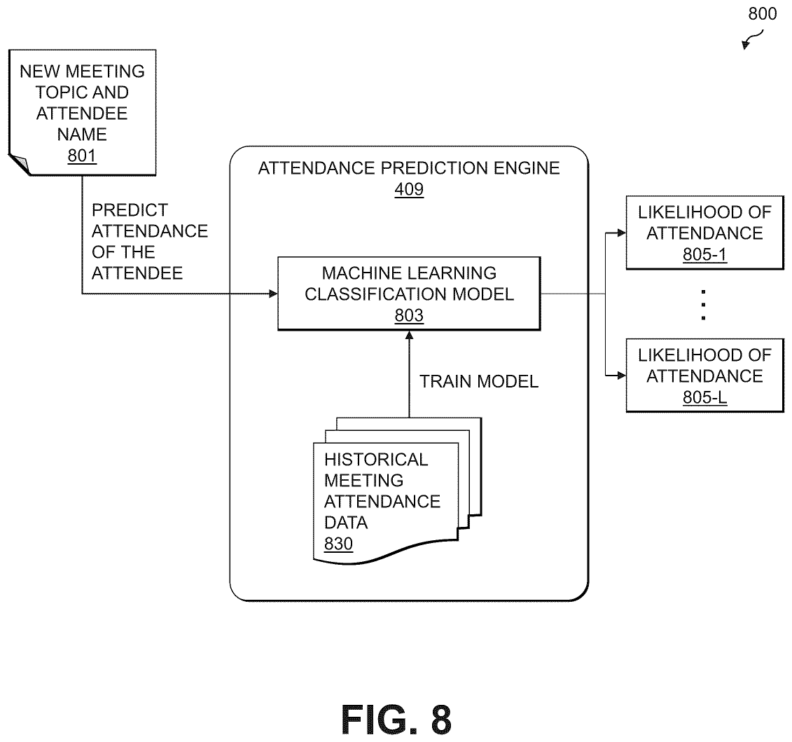

FIG. 8 shows a detailed view of a framework 800 for meeting attendance prediction, in which an input 801 including a new meeting topic and attendee name is provided to the attendance prediction engine 409 implementing a machine learning classification model 803 trained using historical meeting attendance data 830 (e.g., from the meeting attendance repository 411). The machine learning classification model 803 is configured to predict whether the attendee named in the input 801 will attend a given meeting, and outputs one of a set of likelihoods of attendance 805-1, . . . 805-L (collectively, likelihoods of attendance 805). In some embodiments, there are just two likelihoods of attendance 805, a first likelihood 805-1 corresponding to a prediction that the attendee named in the input 801 will attend the given meeting and a second likelihood 805-L corresponding to a prediction that the attendee named in the input 801 will not attend the given meeting. In other embodiments, there may be a more granular output (e.g., some numerical or other prediction score corresponding to any desired numbers or ranges of likelihood of attendance).

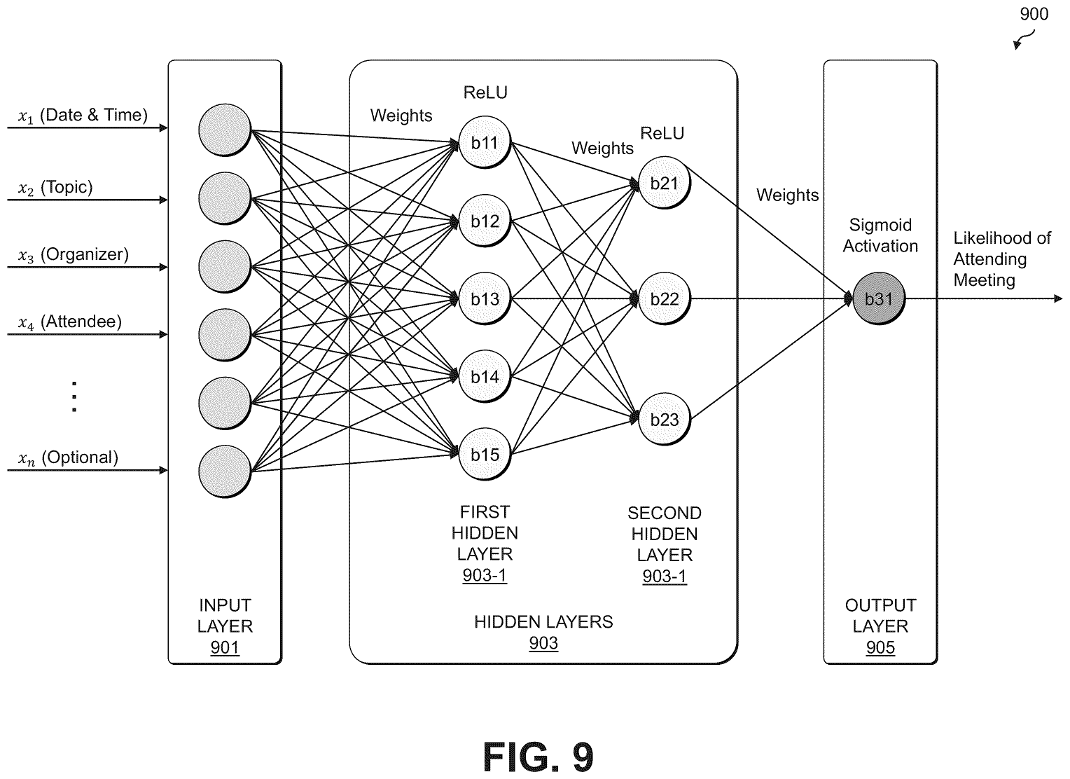

The attendance prediction engine 409 is configured, in some embodiments, to utilize a deep neural network for the machine learning classification model 803. The machine learning classification model 803, for example, may be built as a dense, multi-layer neural network to act as a sophisticated binary classifier. FIG. 9 shows an example architecture 900 for a neural network used in implementing the machine learning classification model 803. The architecture 900 includes an input layer 901, hidden layers 903 (e.g., a first hidden layer 903-1 and a second hidden layer 903-2), and an output layer 905. The input layer 901 includes a number of neurons which matches the number of input independent variables n. The hidden layers 903, in some embodiments, include the first hidden layer 903-1 and the second hidden layer 903-2 where the neurons in each of the first hidden layer 903-1 and the second hidden layer 903-2 depend on the number of neurons in the input layer 901. The output layer 905 includes a single neuron, as it is assumed that the machine learning classification model 803 is a binary classification model, meaning the output is either that the attendee named in the input 801 will or will not attend the given meeting.

It should be noted that FIG. 9, for clarity of illustration, shows only five neurons (also referred to as nodes) in the first hidden layer 903-1 and three neurons in the second hidden layer 903-2. The actual values for the number of neurons in each of the first hidden layer 903-1 and the second hidden layer 903-2 will depend on the total number of neurons in the input layer 901. There is no strict rule for selecting the number of neurons in the hidden layers 903. In some embodiments, a general method of calculation is based on the number of nodes in the input layer 901 where the number of neurons in the first hidden layer 903-1 is selected using an algorithm which matches the power of 2 to the number of nodes in the input layer 901. For example, if the number of input variables is 19, it falls in the range of 2⁵, which means that the first hidden layer 903-1 will have 2⁵=32 neurons. The second hidden layer 903-2 will contain 2⁴=16 neurons. If there were a third hidden layer, it would include 2³=8 neurons. Typically, the neurons in the hidden layers 903 and the output layer 905 will contain an activation function which drives whether each neuron will fire or not. In the architecture 900 shown in FIG. 9, the Rectified Linear Unit (ReLU) activation function is used in the hidden layers 903, and a sigmoid activation function is used in the output layer 905. Various other activation functions may be used in other embodiments.

The architecture 900 shown in FIG. 9 is a dense neural network, where each node/neuron connects with each node/neuron in preceding and subsequent layers. Each connection will have a weight factor, and each of the nodes/neurons will have a bias factor. The weight and bias values may be set randomly by the neural network, which can be started as 1 or 0 for all the values. Each neuron does a linear calculation by combining the multiplication of each input variable (e.g., x₁, x₂, . . . ) with the weight factors and then adding the bias of the neuron. The formula for this calculation is shown below:

$${ws}_{1} = {x}_{1} * {w}_{1} + {x}_{2} * {w}_{2} + … + {b}_{1}$$

where ws₁ is the weighted sum of the neuron 1 (neuron₁). x₁, x₂, etc. are the input values to the machine learning classification model 803 (e.g., date and time, topic, organizer, attendee, etc.), w₁, w₂, etc. are the weight values applied to the connections for neuron₁, and b₁ is the bias value of neuron₁. This weighted sum is input to an activation function (e.g., ReLU) to compute a value of the activation function. Similarly, the weighted sums and activation function values of all other neurons in the layer are calculated. These values are fed to the neurons of the next layer. The same process is repeated in the neurons of the next layer, until the values are fed to the neuron of the output layer. In the output layer, the weighted sum is calculated and compared to an actual target value. Depending on the difference therebetween, the loss value is calculated. This pass through of the neural network is a forward propagation which calculates the error and drives a backpropagation through the neural network to minimize the loss or error at each neuron of the neural network. Considering the error/loss is generated by all the neurons in the neural network, backpropagation goes through each layer from back to forward and tries to minimize the loss by using a gradient descent-based optimization mechanism. Considering the neural network is used here as a binary classifier, various loss functions may be used in the optimization algorithm including but not limited to “binary_crossentropy” and adam (adaptive moment estimation), RMSProp, etc.

The result of the backpropagation is to adjust the weight and bias values each connection and neuron level to reduce the error/loss. Once all the observations of the training data are passed through the neural network, an epoch is completed. Another forward propagation is initiated with the adjusted weight and bias values, which are considered as a next epoch and the same process of forward and backpropagation is repeated in subsequent epochs. This process of repeating the epochs results in the reduction of loss to a very small number (e.g., close to 0), at which point the neural network is considered to be sufficiently trained for prediction.

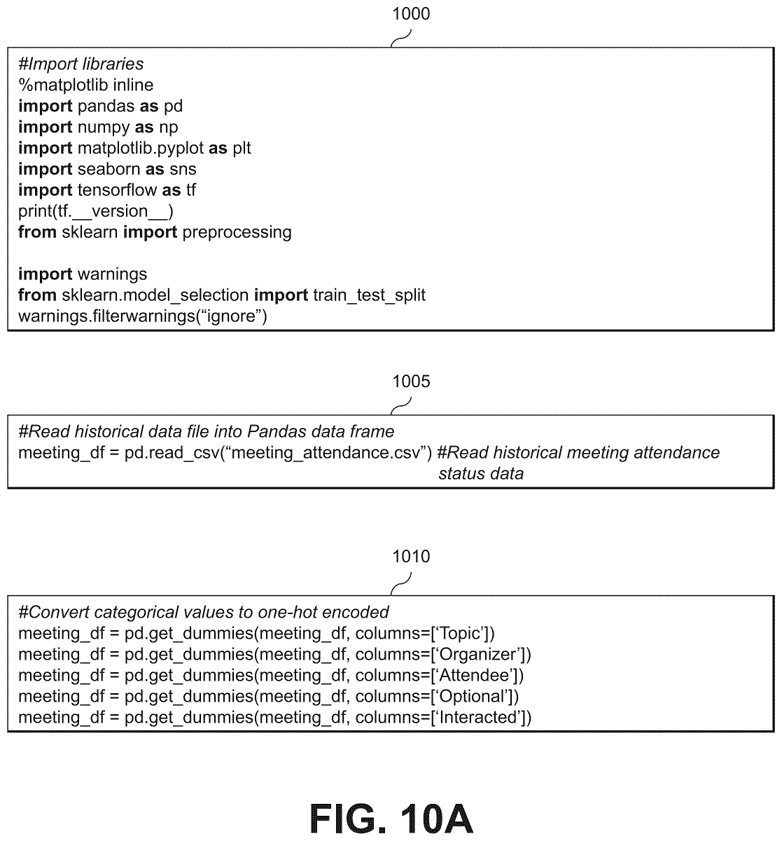

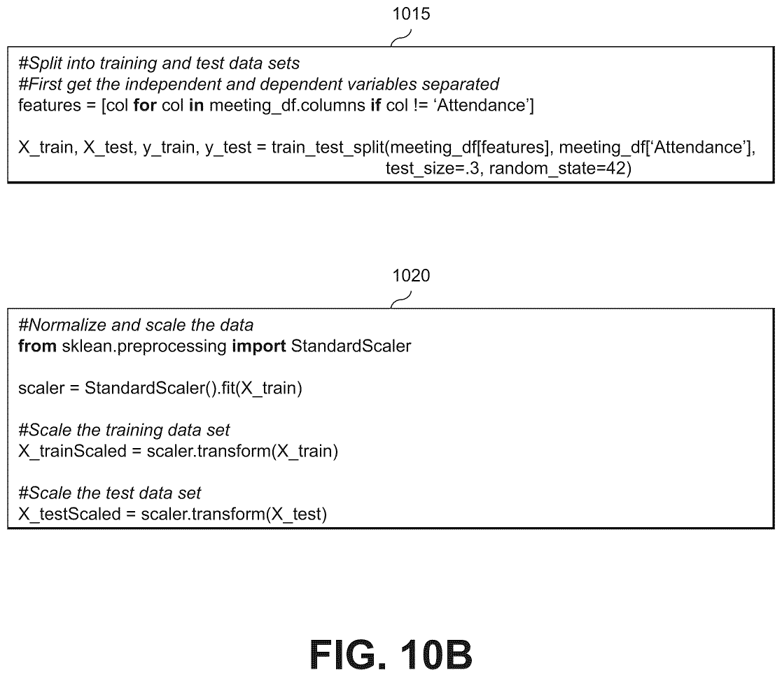

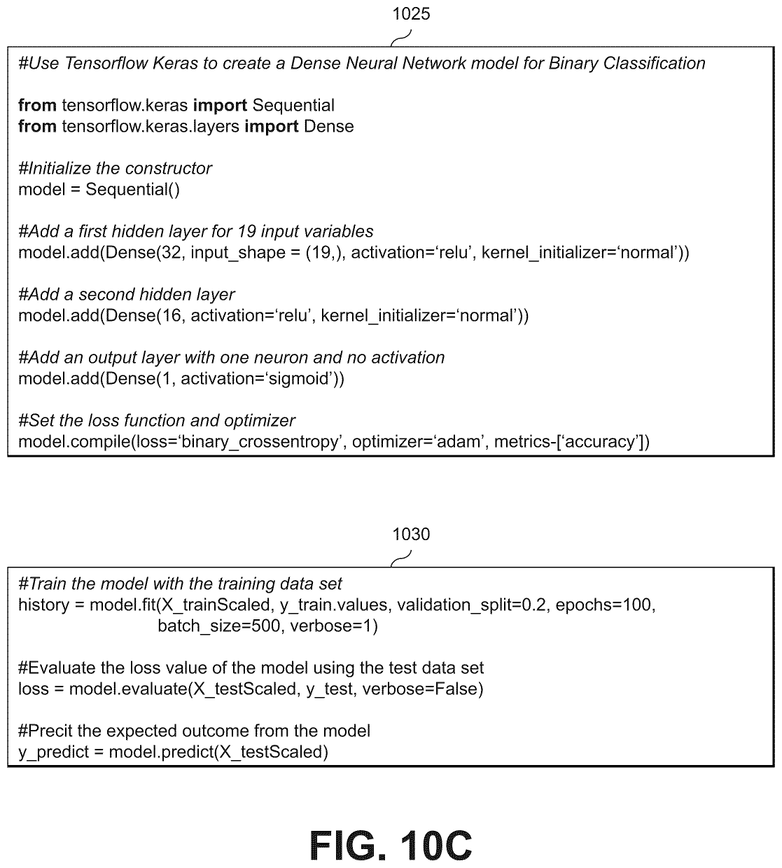

An example implementation of the smart meeting framework 400 will now be described with respect to the pseudocode shown in FIGS. 10A-10C. In the example of FIGS. 10A-10C, the smart meeting framework 400 is implemented using Keras with a Tensorflow backend, the Python programming language, and Pandas, Numpy and ScikitLearn libraries. To begin, data pre-processing will be described were all the data from the meeting attendance repository 411 is read and a Pandas data frame is generated. This contains all the columns including independent variables and dependent/target variable columns. The initial step will be to conduct pre-processing of data to handle any null or missing values in the columns. Null/missing values in the numerical columns can be replaced, for example, by the median value of that column. After doing initial data analysis by creating some univariate and bivariate plots of these columns, the importance and influence of each column can be understood. Columns which have no role or influence on the outcome (the target variables) should be dropped. FIG. 10A shows pseudocode 1000 for importing necessary libraries, as well as pseudocode 1005 for reading the historical data file into a Pandas data frame. As machine learning models deal with numerical values, textual categorical values in the columns are encoded during the pre-processing stage as shown in the pseudocode 1010 of FIG. 10A for converting categorical values to one-hot encoded values. For example, topic, organizer, attendee, optional and interacted variables are encoded using one-hot encoding or dummy variable encoding (e.g., the “get_dummies” function of the Pandas library).

The whole data set is then split into training and testing data sets using the “train test split” function of the ScikitLearn library as shown in the pseudocode 1015 of FIG. 10B. In this example, a 70%/30% training/test split is used. Considering this is a binary classification use case and a dense neural network will be used as the machine learning classification model 803, it is important to scale the data before it is passed to the machine learning classification model 803. The scaling should be performed after the training and testing split is done, and is illustrated in the pseudocode 1020 of FIG. 10B. This can be achieved by passing the training and test data sets to the “StandardScaler” function of the ScikitLearn library. At the end of these activities, the data is ready for model training/testing.

Neural network model creation will now be described with respect to the pseudocode shown in FIG. 10C. A multi-layer dense neural network is created using the Keras library as shown in the pseudocode 1025 of FIG. 10C. Using the function “Sequential( )”, a shell model is created. Individual layers are then added by calling the “add( )” function and passing an instance of “Dense( )” to indicate that it is a dense neural network. In this way, all of the neurons of each layer will connect with all of the neurons from the preceding and following layer. The “Dense( )” function will accept parameters for the number of neurons on that layer, the type of activation function used, and if there are any kernel parameters. Multiple hidden layers are added by calling the same “add( )” function, and the output layer is similarly added by calling the “add( )” function. Once the model is created, the loss function, optimizer type and validation metrics are added using the “compile( )” function. In some embodiments, as binary classification is performed, “binary_crossentropy” is used as the loss function, “adam” is used as the optimizer, and “accuracy” is used as the metrics.

Model training, validation, optimization and prediction are illustrated in the pseudocode 1030 of FIG. 10C. Neural network model training is achieved by calling the “fit( )” function and passing the training data and the number of epochs. After the model completes the specified number of epochs, it is trained and ready for validation. The loss/error value can be obtained by calling the “evaluate( )” function and passing the test data set. This loss value indicates how well the model is trained. A higher loss value means the model is not trained enough, and that hyperparameter tuning may be required. Typically, the number of epochs can be increased to train the model more. Other hyperparameter tuning can be done by changing the loss function, the optimizer algorithm, or even by making changes to the architecture of the neural network (e.g., adding more hidden layers). Once the model is fully trained with a reasonable loss value (e.g., as close to 0 as possible), it is ready for prediction. Prediction of the model is achieved by calling the “predict( )” function and passing the independent variables of the test data set (e.g., for comparing the training versus the test data sets), or by passing the independent variables for “real” values for which it is desired to predict the target variables (e.g., whether specific potential invitees will or will not attend a given meeting). The default threshold of the success score in sigmoid activation is 50% (e.g., above that score is considered a “yes” and below that score is considered “no”), but this may be adjusted to a higher value as needed or desired.

In some embodiments, the smart meeting engine 405 is configured to provide post-meeting feedback to the meeting organizer 401. The recap provided to the meeting organizer 401 shows the original predicted criticality of each user (e.g., each invitee/attendee) and the results of the completed meeting (e.g., minutes actively talking, sharing the screen, providing feedback, etc.). For recurring meetings, this provides an easy way for the meeting organizer 401 to “downgrade” invitees (e.g., from required to optional, from optional to informational, etc.), to “upgrade” invitees (e.g., from informational to optional, from optional to required, etc.), for removing invitees, etc. In some cases, the meeting organizer 401 may remove or downgrade a user, while still providing that user with a for your information (FYI) notification of meeting recordings. The post-meeting feedback may include invitee votes or scores on the usefulness of a meeting, the relevance of the meeting for one or more designated topics, etc. Such post-meeting feedback may be obtained by querying or determining the interactions of each attendee during a meeting. If specific attendees do not interact in the meetings for some time, or do not attend, the machine learning classification model 803 of the attendance prediction engine 409 can learn that pattern and adjust future predictions accordingly.

The technical solutions described herein introduce predictive intelligence of meeting priority for individual invitees/attendees based on multi-dimensional factors including, but not limited to, topic, organizer/coordinator, participants, past participants, etc. The technical solutions utilize sophisticated natural language processing with neural networks to predict the topic of a meeting from its meeting description, which is used as input for predicting invitee/attendee participation. The technical solutions further leverage a neural network-based classifier to calculate the priority score of attendees which may be used by the attendees for determining whether or not to attend a meeting.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for intelligent meeting scheduling will now be described in greater detail with reference to FIGS. 11 and 12. Although described in the context of system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that may be utilized to implement at least a portion of the information processing system 100 in FIG. 1. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 may comprise respective VMs, respective sets of one or more containers, or respective sets of one or more containers running in VMs.

In some implementations of the FIG. 11 embodiment, the VMs/container sets 1102 comprise respective VMs implemented using virtualization infrastructure 1104 that comprises at least one hypervisor. A hypervisor platform may be used to implement a hypervisor within the virtualization infrastructure 1104, where the hypervisor platform has an associated virtual infrastructure management system. The underlying physical machines may comprise one or more distributed processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of system 100 and includes a plurality of processing devices, denoted 1202-1, 1202-2, 1202-3, . . . 1202-K, which communicate with one another over a network 1204.

The network 1204 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1202-1 in the processing platform 1200 comprises a processor 1210 coupled to a memory 1212.

The processor 1210 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1212 may comprise random access memory (RAM), read-only memory (ROM), flash memory or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for intelligent meeting scheduling as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, information technology assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to obtain a first data structure characterizing a description of a given meeting;
to perform natural language processing of the first data structure utilizing a first machine learning model to identify one or more topics for the given meeting;
to obtain a second data structure characterizing one or more potential invitees for the given meeting;
to create a third data structure characterizing the identified one or more topics of the given meeting and a given one of the one or more potential invitees for the given meeting;
to process the third data structure utilizing a second machine learning model to generate a prediction as to a likelihood of the given potential invitee attending the given meeting; and
to generate an invitation to the given meeting for the given potential invitee based at least in part on the prediction of the likelihood of the given potential invitee attending the given meeting.

2. The apparatus of claim 1 wherein the first machine learning model comprises a Recurrent Neural Network (RNN) machine learning model.

3. The apparatus of claim 2 wherein the RNN machine learning model comprises a bi-directional RNN with Long Short Term Memory (LS™).

4. The apparatus of claim 1 wherein the first machine learning model is trained utilizing a corpus of meeting topics associated with an enterprise for which the given meeting is scheduled.

5. The apparatus of claim 1 wherein the second machine learning model comprises a binary classification model that provides, as output, a prediction of whether or not the given potential invitee will attend the given meeting.

6. The apparatus of claim 1 wherein the second machine learning model is trained utilizing information characterizing one or more historical meetings of an enterprise for which the given meeting is scheduled, the information characterizing the one or more historical meetings including, for each historical meeting, one or more meeting topics, one or more organizers, one or more attendees, and a level of interaction of each of the one or more attendees.

7. The apparatus of claim 1 wherein the second machine learning model comprises a dense artificial neural network-based classifier comprising an input layer, one or more hidden layers, and an output layer.

8. The apparatus of claim 7 wherein the input layer is configured to receive values for a set of independent variables characterizing a likelihood of the given potential invitee attending the given meeting.

9. The apparatus of claim 8 wherein the set of independent variables comprises:
a date and time of the given meeting;
the identified one or more topics for the given meeting; and
an organizer of the given meeting.

10. The apparatus of claim 7 wherein each of the one or more hidden layers comprises a set of neurons utilizing a first activation function, and wherein the output layer comprises a single neuron utilizing a second activation function.

11. The apparatus of claim 10 wherein the first activation function comprises a Rectified Linear Unit (ReLU) activation function and the second activation function comprises a sigmoid activation function.

12. The apparatus of claim 1 wherein the generated invitation to the given meeting for the given potential invitee specifies an attendee class for the given potential invitee based at least in part on the prediction of the likelihood of the given potential invitee attending the given meeting, the attendee class comprising one of a required attendee and an optional attendee.

13. The apparatus of claim 1 wherein the at least one processing device is further configured to obtain post-meeting feedback for the given meeting, and to utilize the post-meeting feedback for updating a training of the second machine learning model.

14. The apparatus of claim 13 wherein the post-meeting feedback characterizes at least one of: whether the given potential invitee attended the given meeting; and a level of interaction of the given potential invitee during the given meeting.

15. A computer program product comprising a non-transitory processor-readable storage medium having stored therein program code of one or more software programs, wherein the program code when executed by at least one processing device causes the at least one processing device:
to obtain a first data structure characterizing a description of a given meeting;
to perform natural language processing of the first data structure utilizing a first machine learning model to identify one or more topics for the given meeting;
to obtain a second data structure characterizing one or more potential invitees for the given meeting;
to create a third data structure characterizing the identified one or more topics of the given meeting and a given one of the one or more potential invitees for the given meeting;
to process the third data structure utilizing a second machine learning model to generate a prediction as to a likelihood of the given potential invitee attending the given meeting; and
to generate an invitation to the given meeting for the given potential invitee based at least in part on the prediction of the likelihood of the given potential invitee attending the given meeting.

16. The computer program product of claim 15 wherein the first machine learning model comprises a bi-directional Recurrent Neural Network (RNN) with Long Short Term Memory (LS™).

17. The computer program product of claim 15 wherein the second machine learning model comprises a dense artificial neural network-based classifier comprising an input layer, one or more hidden layers, and an output layer.

18. A method comprising:
obtaining a first data structure characterizing a description of a given meeting;
performing natural language processing of the first data structure utilizing a first machine learning model to identify one or more topics for the given meeting;
obtaining a second data structure characterizing one or more potential invitees for the given meeting;
creating a third data structure characterizing the identified one or more topics of the given meeting and a given one of the one or more potential invitees for the given meeting;
processing the third data structure utilizing a second machine learning model to generate a prediction as to a likelihood of the given potential invitee attending the given meeting; and
generating an invitation to the given meeting for the given potential invitee based at least in part on the prediction of the likelihood of the given potential invitee attending the given meeting;
wherein the method is performed by at least one processing device comprising a processor coupled to a memory.

19. The method of claim 18 wherein the first machine learning model comprises a bi-directional Recurrent Neural Network (RNN) with Long Short Term Memory (LS™).

20. The method of claim 18 wherein the second machine learning model comprises a dense artificial neural network-based classifier comprising an input layer, one or more hidden layers, and an output layer.
